(19) United States
(12) Patent Application Publication
(10) Pub. No.: US 2014/0199001 A1
(43) Pub. Date: Jul. 17, 2014

(54) STORGE BAG HAVING A LIQUID ABSORBING SPACER

(71) Applicant: James Haluck, Reno, NV (US)

(72) Inventor: James Haluck, Reno, NV (US)

(21) Appl. No.: 13/740,532

(22) Filed: Jan. 14, 2013

(51) Int. Cl. B31B 1/00; B65D 33/00

(52) U.S. Cl. CPC B31B 1/00; B65D 33/00
USPC 383/109; 383/105; 493/267

(57) ABSTRACT

A storage bag includes an upper layer and a lower layer. The lower layer is bonded to the upper layer. An internal cavity is formed by the layers. An edge is formed by the upper and lower layers. The edge has an opening to provide access to the internal cavity. A spacer is mounted within the internal cavity. The spacer may include at least one channel or cavity that holds liquid in the storage bag when suction is applied to the internal cavity. The spacer provides a structure that prevents the flexible material of the bag layers from moving inward and exerting a pressure on the liquid. The retention of the liquid by the spacer prevents liquid from contaminating the vacuum sealing machine.

### CROSS REFERENCE TO RELATED APPLICATIONS

This application claims priority to U.S. provisional patent application Ser. No. 61/586,682 filed Jan. 13, 2012, and U.S. provisional patent application Ser. No. 61/586,997 filed Jan. 16, 2012, the contents of which is herein incorporated by reference.

### FIELD OF THE INVENTION

The present invention relates to storage bags used for vacuum sealing of food. More specifically, the invention relates to heat sealable storage bags that have a liquid absorbing spacer.

### BACKGROUND

Storage bags are known in the art and many different types of storage bags have been developed. One type of storage bag is a heat sealable storage bag that uses heat to seal the bag. Once a user has placed objects, items or material to be sealed into the storage bag, a vacuum is applied using a vacuum pump to remove excess air from the storage bag. Heat is applied to the storage bag to create a seal and seal the contents within the bag. One of the problems associated with this type of storage bag system is that when wet items are placed in the bag, the vacuum pump can suck or vacuum liquid out of the storage bag. For example, if beef stew is placed in the storage bag, liquid in the stew will be drawn out of the bag. The liquid may collect in a cavity in the vacuum sealing machine that is intended to hold the liquid. However, this cavity can overflow and the liquid can be sucked into the vacuum pump thereby clogging or damaging the vacuum pump or other parts. Even if the reservoir does not overflow, the vacuum sealing machine can become dirty with the liquid and contaminated with bacteria. This can become a significant issue when the storage bag system is used to store food.

### SUMMARY OF ONE EMBODIMENT OF THE INVENTION

### Brief Description of One Embodiment of the Present Invention

In one embodiment, the present invention comprises a storage bag. The storage bag includes an upper layer and a lower layer. The lower layer is bonded to the upper layer. An internal cavity is formed by the layers. An edge is formed by the upper and lower layers. The edge has an opening to provide access to the internal cavity. A spacer is mounted within the internal cavity to hold or retain liquid. The spacer has a first wall and a second wall substantially opposed to the first wall. At least one inner wall extends between the first wall and the second wall. A plurality of channels are defined by the first wall, second wall and at least one inner wall.

In one embodiment, the present invention comprises a spacer. The spacer has a first wall and a second wall substantially opposed to the first wall. At least one inner wall extends between the first wall and the second wall. At least one cavity is defined by the first wall, second wall and at least one inner wall.

In one embodiment, the present invention comprises a method for producing a storage bag. The method may comprise providing a first layer and a second layer bonded to the first layer to define an internal cavity between the first layer and the second layer and an opening to the internal cavity. A spacer may be provided in the internal cavity. Contents may be provided into the internal cavity prior to evacuating and sealing the storage bag. The spacer may comprise a first wall and a second wall substantially opposed to the first wall. At least one inner wall extends between the first wall and the second wall. At least one channel is are defined by the first wall, second wall and at least one inner wall.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herin are for the purpose of description and should not be regarded as limiting.

### Advantages of One or More Embodiments of the Present Invention

The various embodiments of the present invention may, but do not necessarily, achieve one or more of the following advantages:

The ability to provide a storage bag that has a liquid absorbing spacer;

The ability to provide a storage bag that prevents liquid within the bag from leaving the bag when suction is applied to the bag by a vacuum sealing machine;

Provide a storage bag having a spacer with channels for holding liquid;

Provide a storage bag that can hold or retain liquid;

Provide a pliable or flexible spacer that can hold or retain liquid;

These and other advantages may be realized by reference to the remaining portions of the specification, claims, and abstract.

### BRIEF DESCRIPTION OF THE DRAWINGS

FIG. 1 is substantially a top view of a storage bag in accordance with the present invention.

FIG. 2 is substantially a side cross sectional view of a portion of the storage bag of FIG. 1.

FIG. 3 is substantially a top view of a storage bag having a liquid absorbing spacer in accordance with the present invention.

FIG. 4 is substantially a perspective view of an embodiment of a liquid absorbing spacer.

FIG. 5 is substantially a side view of the liquid absorbing spacer of FIG. 4.

FIG. 6 is substantially a top view of another embodiment of a storage bag having a liquid absorbing spacer in accordance with the present invention.

FIG. 7 is substantially a top view of an additional embodiment of a storage bag having a liquid absorbing spacer in accordance with the present invention.

FIG. 8 is substantially a perspective view of an embodiment of a liquid absorbing spacer.

FIG. 9 is substantially a side view of the liquid absorbing spacer of FIG. 8.

FIG. 10 is substantially a flowchart of a method of producing a storage bag.

FIG. 11 is substantially a perspective view of an embodiment of a liquid absorbing spacer.

FIG. 12 is substantially a side view of the liquid absorbing spacer of FIG. 11.

FIG. 13 is substantially a perspective view of an embodiment of a liquid absorbing spacer.

FIG. 14 is substantially a side view of the liquid absorbing spacer of FIG. 13.

FIG. 15 is substantially a perspective view of an embodiment of a liquid absorbing spacer.

FIG. 16 is substantially a side view of the liquid absorbing spacer of FIG. 15.

FIG. 17 is substantially a perspective view of an embodiment of a liquid absorbing spacer.

FIG. 18 is substantially a side view of the liquid absorbing spacer of FIG. 17.

FIG. 19 is substantially a perspective view of an embodiment of a liquid absorbing spacer.

FIG. 20 is substantially a side view of the liquid absorbing spacer of FIG. 29.

FIG. 21 is substantially a perspective view of an embodiment of a liquid absorbing spacer.

FIG. 22 is substantially a side view of the liquid absorbing spacer of FIG. 21.

FIG. 23 is substantially a perspective view of an embodiment of a liquid absorbing spacer.

FIG. 24 is substantially a side view of the liquid absorbing spacer of FIG. 23.

FIG. 25 is substantially a perspective view of one more embodiment of a liquid absorbing spacer.

FIG. 26 is substantially a side view of the liquid absorbing spacer of FIG. 25.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

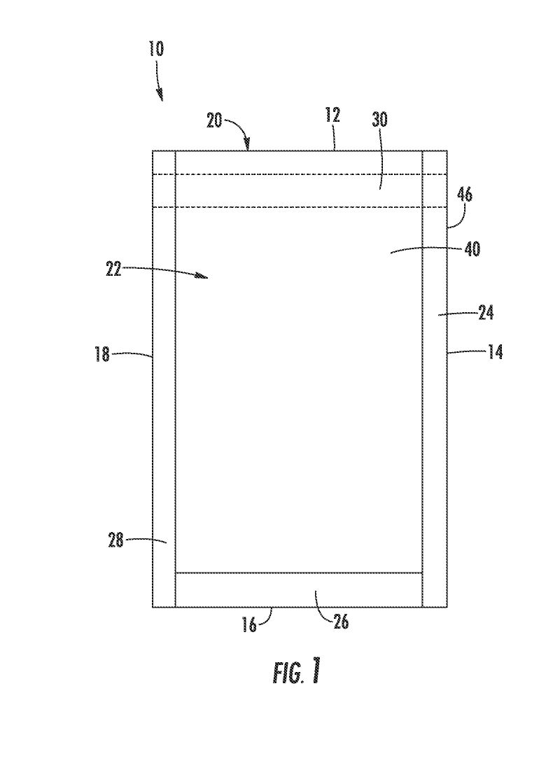

The present invention comprises a storage bag, generally indicated by reference number 10. Referring to FIG. 1, storage bag 10 comprises a first edge 12, a second edge 14, a third edge 16 and a fourth edge 18. Storage bag 10 has a height that is determined by the distance between first edge 12 and third edge 16 and a width that is determined by the distance between second edge 14 and fourth edge 18. Storage bag 10 shown in the figures is rectangular, however, it is recognized that storage bag 10 may be made in a large variety of shapes, such as circular. Storage bag 10 is formed from an upper layer 40 and a lower layer 46.

An opening 20 is provided at first edge 12 of storage bag 10 for allowing access to an internal cavity 22. Storage bag 10 further includes seams 24, 26 and 28 that are adjacent to second edge 14, third edge 16 and fourth edge 18, respectively. Another seam 30 can be located toward edge 12. As shall be discussed in more detail below, seams 24, 26, 28 and 30 are formed by heat bonding layers of material together.

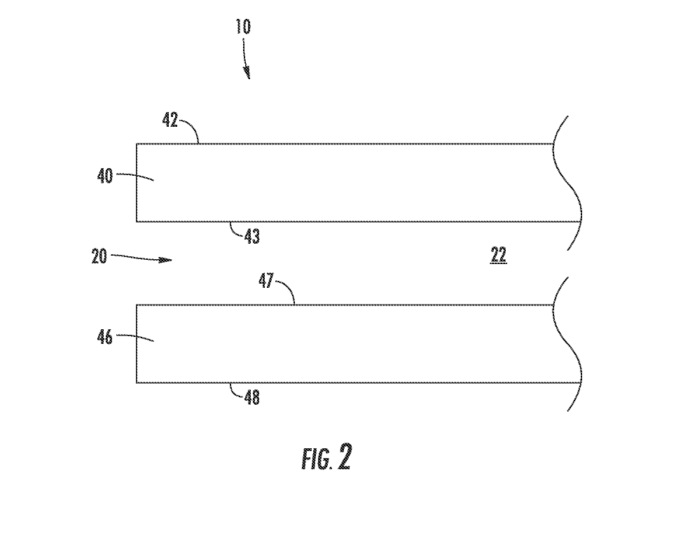

With additional reference to FIG. 2, storage bag 10 of the present invention includes an upper layer 40 and a lower layer 46. Upper layer 40 has an outer surface 42 and an inner surface 43. Lower layer 46 has an outer surface 48 and an inner surface 47. In FIG. 2, only a portion of storage bag 10 is shown. Outer surfaces 42 and 48 form a portion of the exterior surface of storage bag 10 and inner surfaces 43 and 47 form a portion of the surfaces that defines internal cavity 22.

Upper layer 40 and lower layer 46 may be formed of any suitable material such as plastics, nylon, low density polyethylene or high density polyethylene that can be bonded together. When storage bag 10 is manufactured, upper layer 40 is positioned on lower layer 46 and heat is applied to the peripheral portions of the layers the two sheets. The heat can be applied by a heat sealing machine. This causes layers 40 and 46 to weld or fuse together forming seams 24, 26 and 28. In a similar manner, seam 30 can be formed at a later time after cavity 22 is filled with a material that is desired to be sealed within storage bag 10.

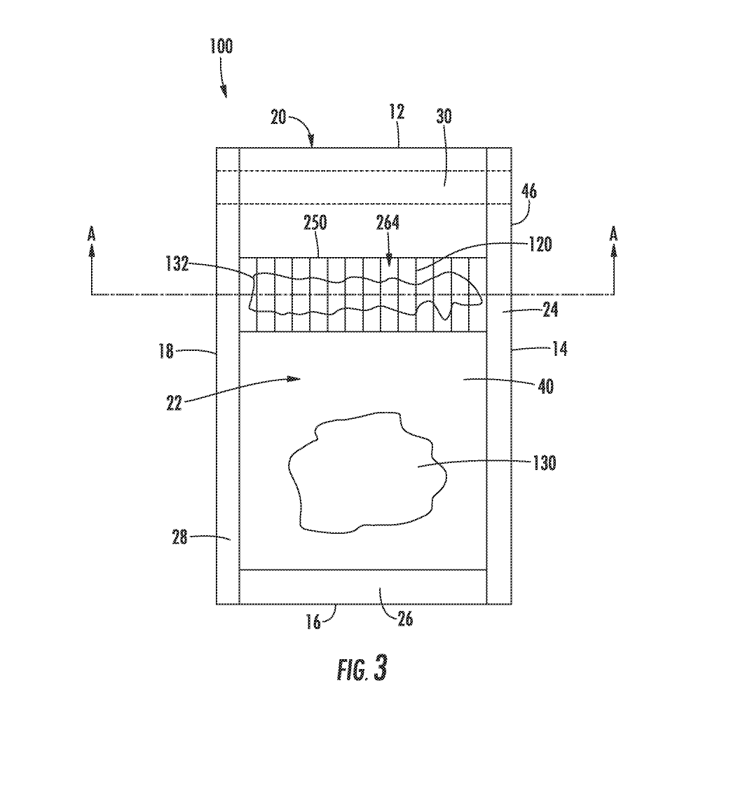

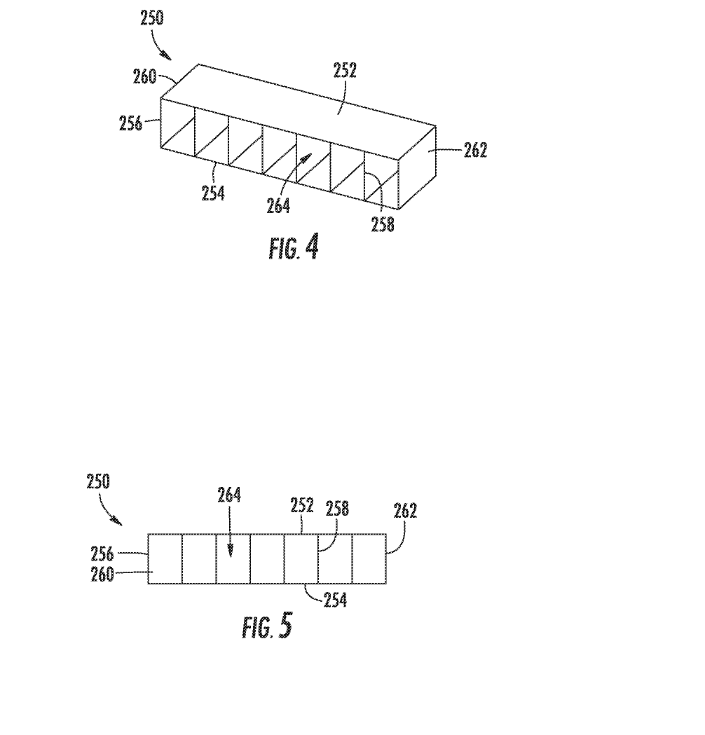

Turning now to FIGS. 3-5, an additional embodiment of a storage bag 100 of the present invention is shown. Storage bag 100 is similar to storage bag 10 except that a liquid absorbing or holding spacer 250 has been mounted within internal cavity 22 between upper layer 40 and lower layer 46. Spacer 250 is rectangular in shape. Spacer 250 includes a first wall 252, second wall 254, outer walls 256 and inner walls 258. Spacer 250 has ends 260 and 262. Spacer 250 has several cavities or channels 264 that are defined by the first wall 252, second wall 254 and inner walls 258 and extend through spacer 250. Cavities or channels 264 can hold or retain liquid. Spacer 250 can be mounted within internal cavity 22 (FIG. 3) of the storage bag and be used to hold or retain liquid.

Spacer 250 extends across the width of storage bag 100 between seams 24 and 28 with end 116 abutting seam 28 and end 118 abutting seam 24. Spacer 250 extends across the height of storage bag 100 between upper layer 40 and lower layer 46 with upper surface of wall 252 abutting upper layer 40 and lower surface of lower wall 254 abutting lower layer 46. Spacer 250 is shown placed towards end 12 and adjacent seam 30; However, spacer 250 can be placed anywhere along the length of storage bag 100.

In one embodiment, spacer 250 is a free standing piece that is placed within internal cavity 22. In another embodiment, spacer 250 can be provided integrally with one of layers 40 or 60, e.g. by affixing spacer 250 to one of layers 40 or 46. Spacer 250 can be affixed to layers 40 or 46 by suitable fastening methods such as heat welding, ultrasonic welding or by an adhesive. Layers 40 and 46 can be formed as rolls of material. Spacer 250 is located within internal cavity 22 after storage bag 100 has been formed. In another embodiment, spacer 250 is formed on a roll of material and formed along with storage bag 100. For example, spacer 110 may be provided on a roll or spool. As storage bag 100 is formed, the spacer 250 is unwound from the roll and welded into one of bag layers 40 or 46.

Spacer 250 can be formed from a variety of different materials, such as polyethylene, polypropylene or nylon. Spacer 250 may be formed in a variety of ways, such as extruded or injection molded.

The structure of spacer 250 is sufficiently rigid to withstand the pressure created by atmospheric pressure acting on the evacuated storage bag. However, spacer 250 can be flexible enough to store the storage bags on a roll or spool. More than one spacer 250 can be placed within internal cavity 22 of storage bag 100.

As illustrated in FIG. 3, storage bag 100 is shown holding or containing a food item 130. Food item 130 can contain amounts of a liquid 132. Spacer 250 absorbs and holds the liquid 132 to prevent the liquid 132 from leaving storage bag 100 through opening 20 when a section source such as a vacuum pump is used to remove air from within internal cavity 22. Spacer 250 provides one or more channels or cavities 264 that each are capable of holding a predetermined volume of liquid 132. In one embodiment, spacer 250 can hold approximately 10 cubic centimeters of liquid. Other embodiments can hold more or less liquid. Spacer 250 absorbs and holds the liquid 132 to prevent the liquid 132 from entering the vacuum pump that is applying suction. After food item 130 is placed within internal cavity 22, a vacuum sealing machine (not shown) can be used to draw a vacuum within cavity 22 and form seam 30 thereby sealing the food item 130 within cavity 22.

The spacer 250 may have an internal volume or it may form a volume with the outer layers 40 and 46. In various embodiments, liquid 132 may flow into or out from spacer 250. In one embodiment, liquid 132 may flow out or away from spacer 250 after the vacuum within internal cavity 22 of storage bag 10 is released, e.g. when the storage bag is opened and the contents are emptied.

In another embodiment, spacer 250 is formed from a material that is pliable or flexible enough to allow the spacer to be compressed or squeezed forcing liquid 132 that is retained within channels or cavities 264 to flow or move out from cavities 264 and away from spacer 110.

Turning to FIG. 6, another embodiment of a storage bag 150 of the present invention is shown. Storage bag 150 is similar to storage bag 100 except that the liquid absorbing or holding spacer 250 has been mounted in a U-shaped configuration along seam 26 and the bottom portions of seams 24 and 28. Spacer 250 with channels or cavities 264 is located within internal cavity 22 between upper layer 40 and lower layer 46.

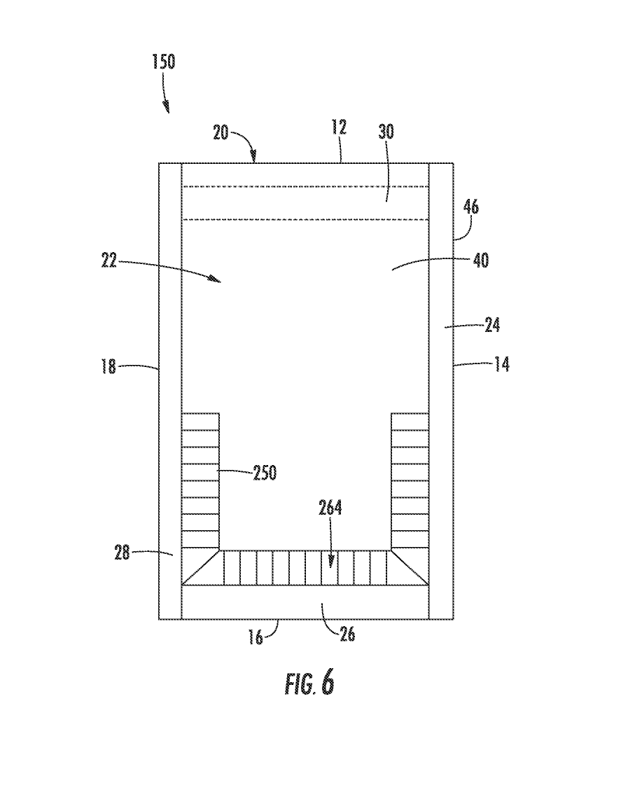

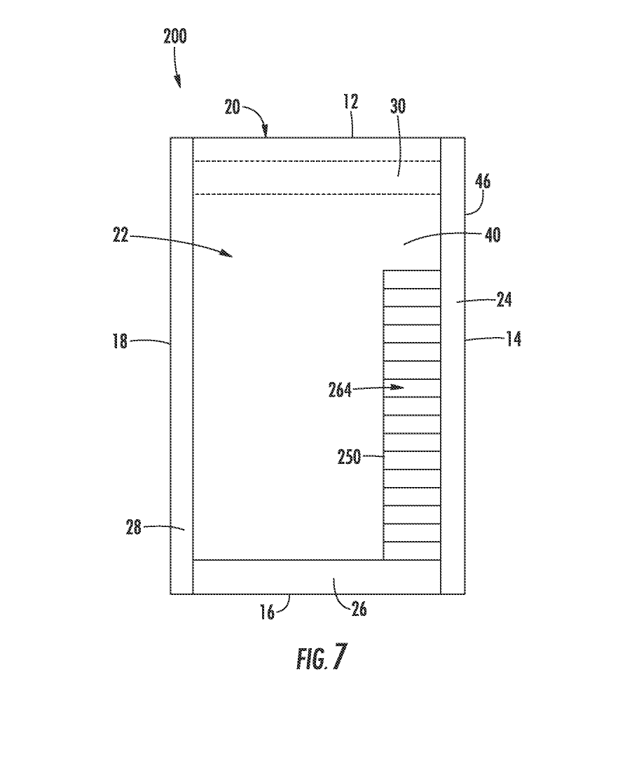

With reference to FIG. 7, another embodiment of a storage bag 200 of the present invention is shown. Storage bag 200 is similar to storage bag 100 except that the liquid absorbing or holding spacer 250 has been mounted adjacent side 14 of the storage bag along seam 24. Spacer 250 with channels or cavities 264 is located within internal cavity 22 between upper layer 40 and lower layer 46.

FIGS. 8 and 9 illustrate one embodiment of a liquid absorbing or holding spacer 450. Spacer 450 has a H-shaped cross section. Spacer 450 includes diametrically opposed first and second walls 454 and 456 spaced apart by and extending perpendicularly away from a center wall 452. Spacer 450 has ends 457 and 458. Spacer 450 has an upper cavity or channel 460 and a lower cavity or channel 462 that are defined by central wall 452, walls 454, 456 and the layers 40 or 46 of the storage bag. Cavities or channels 460 and 462 extend along the length of spacer 450. Cavities or channels 460 and 462 can hold or retain liquid. Spacer 450 can be mounted within internal cavity 22 (FIG. 3A) of the storage bag and be used to hold or retain liquid.

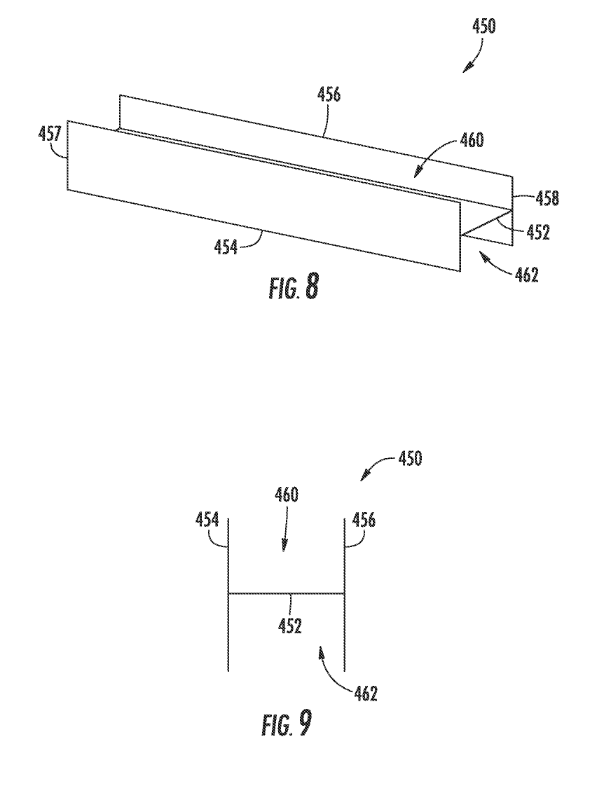

A method of producing an evacuated storage bag will now be described with reference to the flowchart 1000 FIG. 10. At step 1001, the storage bag is provided having first and second layers bonded to define an internal cavity and an opening to the internal cavity. A spacer is provided into the internal cavity at step 1002. However, step 1002 may be provided in conjunction with step 1001 in the event that the spacer is integrally formed with one of the storage bag layers, as described above. Contents are provided into the bag at step 1003. Suction is applied to the bag (step 1004) to remove air from the internal cavity and then the opening is sealed (step 1005). In the process of applying suction, liquid portions of the contents may be retained within the cavities or channels of the spacer, thereby preventing liquids from entering the vacuum sealing machine. It is to be noted that the opening by which suction is provided may be the same opening as the opening through which the contents of the bag are provided, i.e. through which the bag is filled. Alternatively, separate openings may be used for filling the bag and evacuating the bag, in which case the opening through which the contents of the bag are provided may be sealed prior to evacuating the bag.

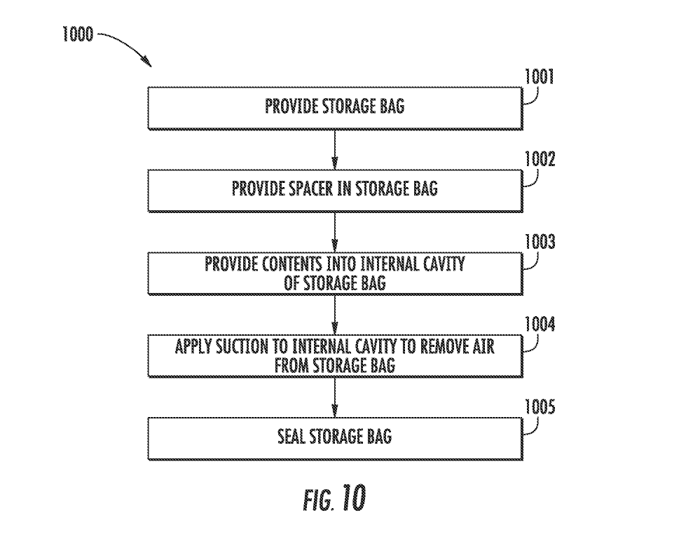

Turning to FIGS. 11 and 12, an additional embodiment of a liquid absorbing or holding spacer 300 is shown. Spacer 300 is oval in shape. Spacer 300 includes a wall 302 having an outer surface 304 and inner surface 305. Spacer 300 has ends 306 and 308. Spacer 300 has a cavity or channel 310 that is defined by wall 302 and extends through spacer 300. Cavity or channel 310 can hold or retain liquid. One or more spacers 300 can be mounted within internal cavity 22 (FIG. 3) of the storage bag and be used to hold or retain liquid.

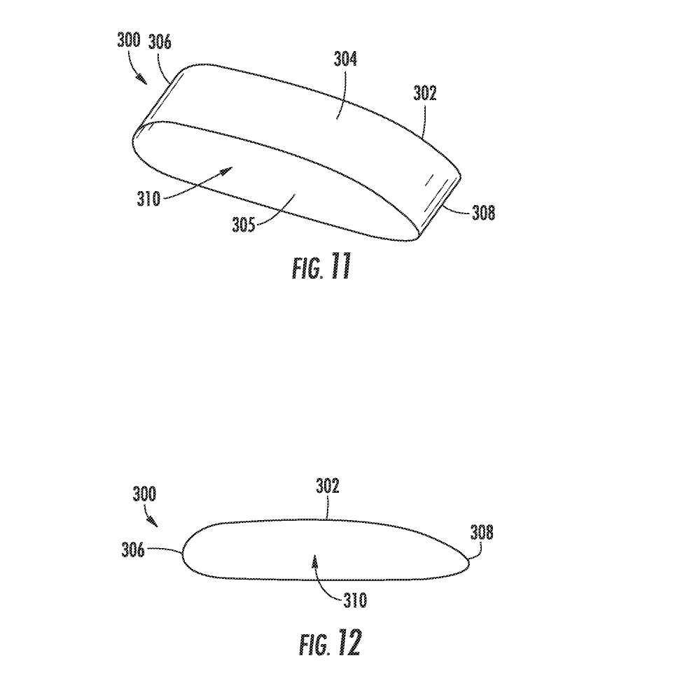

Referring to FIGS. 13 and 14, still another embodiment of a liquid absorbing or holding spacer 350 is shown. Spacer 350 has a rectangular shaped cross section. Spacer 350 includes a wall 352 having an outer surface 354 and inner surface 355. Spacer 350 has ends 350 and 358. Spacer 350 has a cavity or channel 360 that is defined by wall 352 and extends through spacer 350. Cavity or channel 300 can hold or retain liquid. One or more spacers 350 can be mounted within internal cavity 22 (FIG. 3) of the storage bag and be used to hold or retain liquid.

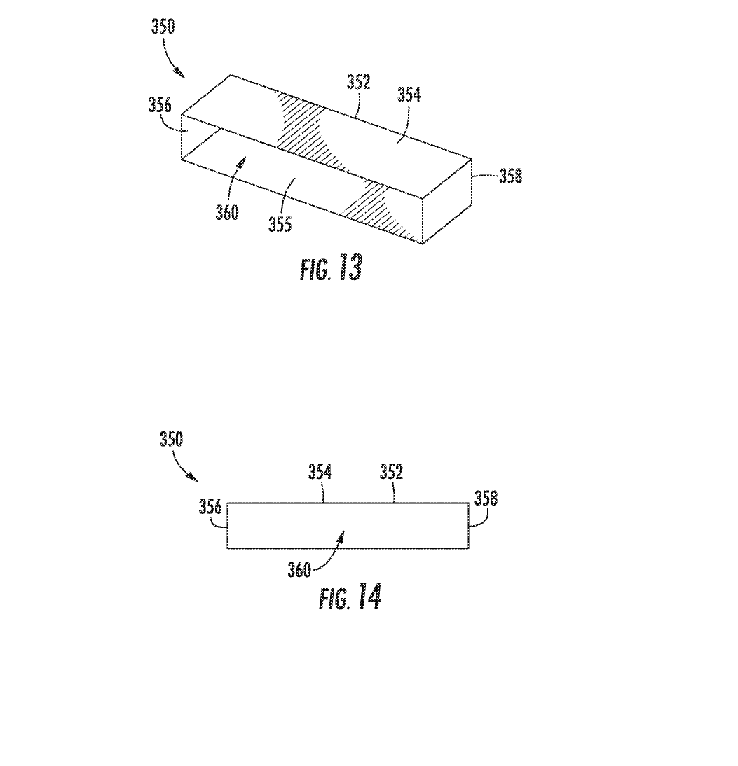

With reference to FIGS. 15 and 16, one more embodiment of a liquid absorbing or holding spacer 400 is shown. Spacer 400 has a U-shaped cross section with walls or ridges. Spacer 400 includes a base or base wall 402 with several walls or ridges 410 extending perpendicularly away from base 402. Spacer 400 has ends 404 and 406. Spacer 400 has several cavities or channels 412 that are defined by base 402, walls 410 and the layers 40 or 46 of the storage bag. Cavities or channels 412 extend through spacer 400. Cavities or channels 412 can hold or retain liquid. One or more spacers 400 can be mounted within internal cavity 22 (FIG. 3) of the storage bag and be used to hold or retain liquid.

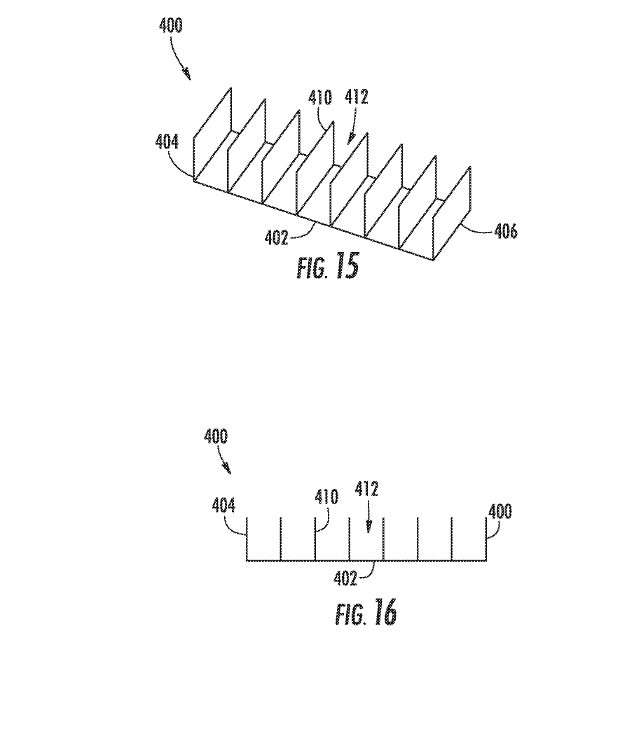

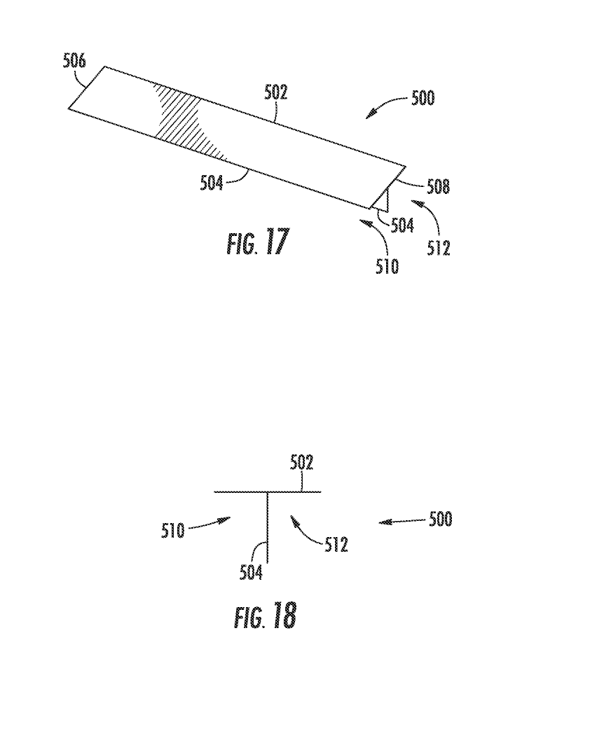

Turning now to FIGS. 17 and 18 an embodiment of a liquid absorbing or holding spacer 500 is shown. Spacer 500 has a T-shaped cross section. Spacer 500 includes a horizontal wall 502 and a vertical wall 504 that extends perpendicularly away from wall 502. Spacer 500 has ends 506 and 508. Spacer 500 has cavities or channels 510 and 512 that are defined by walls 502, 504 and the layers 40 or 46 of the storage bag. Cavities or channels 510 and 512 extend along the length of spacer 500. Cavities or channels 510 and 512 can hold or retain liquid. One or more spacers 500 can be mounted within internal cavity 22 (FIG. 3) of the storage bag and be used to hold or retain liquid.

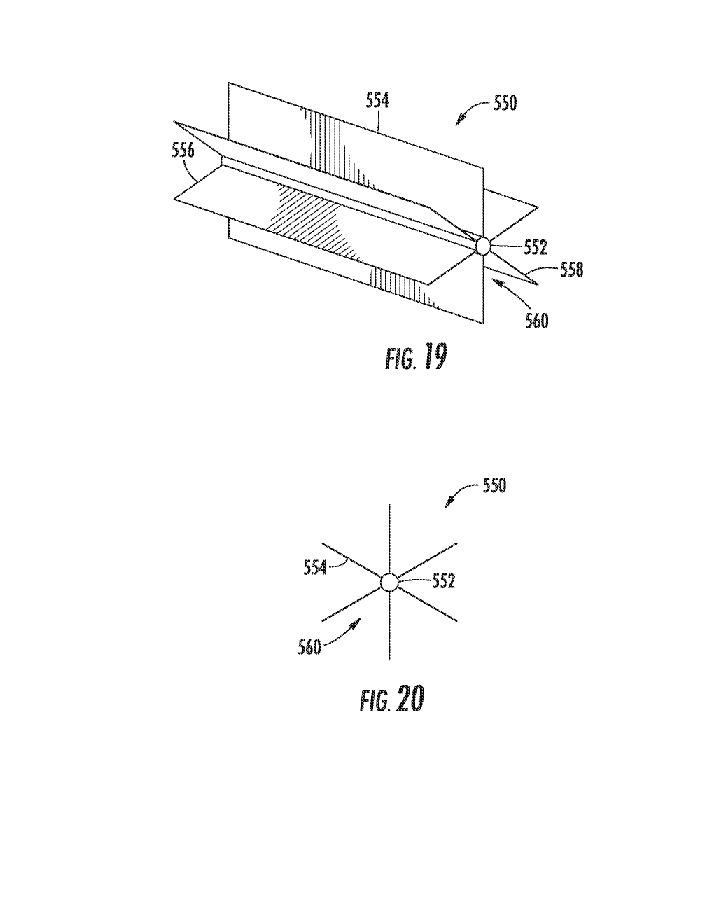

FIGS. 19 and 20 show an embodiment of a liquid absorbing or holding spacer 550. Spacer 550 has a star shaped cross section. Spacer 550 includes a center support 552 and several walls 554 that extend radially away from center support 552. Spacer 550 has ends 556 and 558. Spacer 550 has cavities or channels 560 that are defined by walls 554 and the layers 40 or 46 of the storage bag. Cavities or channels 560 extend along the length or longitudinal axis of spacer 550. Cavities or channels 560 are configured to hold liquid. One or more spacers 550 can be mounted within internal cavity 22 (FIG. 3) of the storage bag and be used to hold liquid.

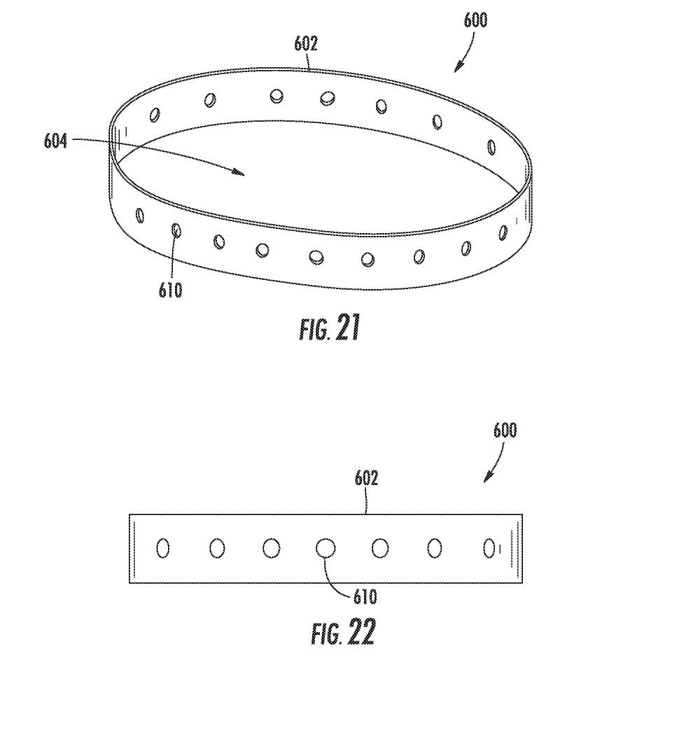

Referring to FIGS. 21 and 22, one more embodiment of a liquid absorbing or holding spacer 600 is shown. Spacer 600 is generally round in shape with an empty center. Spacer 600 includes a circular wall 602 that forms a chamber or cavity 604. Apertures 610 extend through wall 602 around the circumference of wall 602. Chamber or cavity 604 is defined by wall 602 and the layers 40 or 46 of the storage bag. Cavity 604 can hold or retain liquid. Liquid can flow through apertures 610 into cavity 604. One or more spacers 600 can be mounted within internal cavity 22 (FIG. 3) of the storage bag and be used to hold or retain liquid.

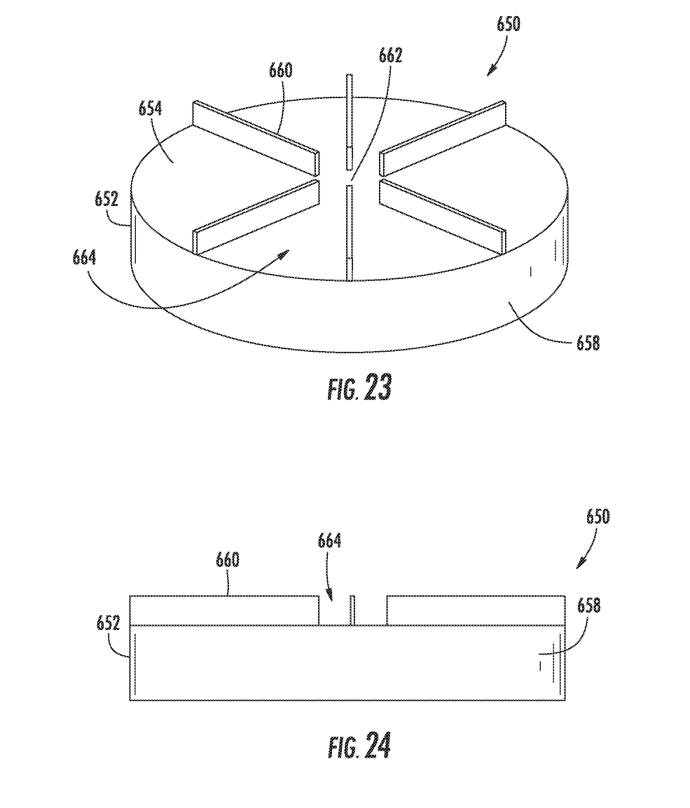

Referring to FIGS. 23 and 24, an additional embodiment of a liquid absorbing or holding spacer 650 is shown. Spacer 650 is generally coin-shaped. Spacer 650 includes a puck 652 with a side surface 658, upper surface 654 and bottom surface 656. Several walls 660 may extend perpendicularly from upper surface 654. Walls 660 extend partially across the radius of spacer 650 and form a central opening 662. Channels or cavities 664 are defined by walls 660, upper surface 654 and the layers 40 or 46 of the storage bag. Cavities 664 can hold liquid. One or more spacers 650 can be mounted within internal cavity 22 (FIG. 3) of the storage bag and be used to hold or retain liquid.

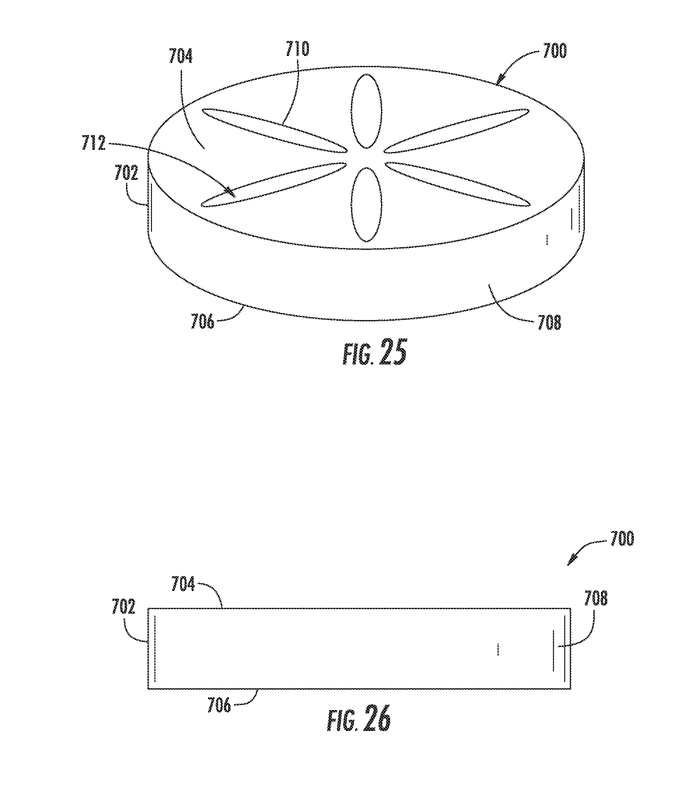

Turning to FIGS. 25 and 26, one more embodiment of a liquid absorbing or holding spacer 700 is shown. Spacer 700 is generally flat cylindrical or coin-shaped. Spacer 700 includes a puck 702 with a side surface 708, upper surface 704 and bottom surface 706. Several openings or vents 710 are located in upper surface 704 and bottom surface 706 and are arranged in a radial manner. The interior of puck 702 is hollow so as to define an internal chamber or cavity 712. Openings or vents 710 provide access into cavity 712 from outside of puck 702. Cavity 712 can hold or retain liquid. The openings or vents 710 allow liquid to enter or exit the internal cavity 712 of spacer 700. One or more spacers 700 can be mounted within internal cavity 22 (FIG. 3) of the storage bag and be used to hold or retain liquid.

The present invention can prevent liquid from being taken up into the suction fluid communication path during vacuum sealing of the storage bag. The present invention prevents the vacuum sealing machine from being contaminated with food sourced liquids.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A storage bag comprising:
(A) an upper layer;
(B) a lower layer at least partially bonded to the upper layer;
(C) an internal cavity formed between the upper layer and the lower layer;
(D) a first edge formed by the bonding of the upper and lower layers, the first edge having an opening providing access to the internal cavity; and
(E) at least one spacer disposed within the cavity, the at least one spacer comprising:
(a) a first wall;
(b) a second wall opposite the first wall;
(c) at least one inner wall that extends between the first wall and the second wall; and
(d) a plurality of channels defined by the first wall, the second wall and the at least one inner wall.

2. The storage bag of claim 1 wherein the spacer is incompressible when suction is applied to the storage bag by a vacuum sealing machine.

3. The storage bag of claim 1 wherein the spacer is configured to retain liquid of storage bag contents in the channels when suction is applied to the internal cavity of the storage bag.

4. The storage bag of claim 3 wherein the channels are configured so that the liquid is retained in the channels when suction is applied to the internal cavity of the storage bag.

5. The storage bag of claim 3 wherein the plurality of channels are configured to release the liquid contents from the channels when the storage bag is opened.

6. The storage bag of claim 1 wherein the spacer comprises a plurality of inner walls extending between the first wall and the second wall.

7. The storage bag of claim 1 wherein the at least one spacer is disposed adjacent the first edge.

8. The storage bag of claim 1 comprising at least one second edge distinct from the first edge, wherein the at least one spacer is disposed adjacent the at least one second edge.

9. The storage bag of claim 1 wherein the spacer is integrally formed with at least one of the upper layer or the lower layer.

10. A spacer for use in an evacuated storage bag, the spacer comprising:
(A) a first wall;
(B) a second wall opposite the first wall;
(C) at least one inner wall that extends between the first wall and the second wall; and
(D) a plurality of cavities defined by the first wall, the second wall and the at least one inner wall.

11. The spacer of claim 10 comprising a plurality of inner walls extending between the first wall and the second wall.

12. A method for producing a storage bag comprising:
(A) providing a first layer and a second layer bonded to the first layer to define an internal cavity between the first layer and the second layer and an opening to the internal cavity;
(B) providing a spacer in the internal cavity, the spacer comprising:
(a) a first wall;
(b) a second wall opposite the first wall;
(c) at least one inner wall that extends between the first wall and the second wall; and
(d) a plurality of channels defined by the first wall, the second wall and the at least one inner wall;
(C) providing contents into the internal cavity;
(D) applying suction to the opening to remove air from the internal cavity; and
(E) sealing the opening.

13. The method of claim 12 comprising providing the spacer integrally with at least one of the first layer or the second layer.

14. The method of claim 12 comprising providing liquid contents into the internal cavity and retaining at least a portion of the liquid contents in the channels during the application of the suction to prevent the liquid contents from leaving the opening during the application of the suction.

15. The method of claim 14 wherein the spacer is configured to release the liquid contents from the spacer when the storage bag is opened and the contents are emptied from the storage bag.
